(19) United States
(12) Patent Application Publication
(10) Pub. No.: US 2020/0305390 A1
(43) Pub. Date: Oct. 1, 2020

(54) Head and Horn Protector

(71) Applicant: Brett L. Siddoway, Hooper, UT (US)

(72) Inventor: Brett L. Siddoway, Hooper, UT (US)

(21) Appl. No.: 16/370,859

(22) Filed: Mar. 29, 2019

(51) Int. Cl. A01K 13/00

(52) U.S. Cl. CPC A01K 13/006

(57) ABSTRACT

A head and horn protector having, on both the left and right sides, a unitary side head pad and rear horn pad, a horn pad linear segment of protective material, a side head pad linear segment of protective material, a left guide of protective material and also having a buckle, a strap, and, for both the left and right sides, a shield. For each side the combined thickness of the rear horn pad, the rear horn pad linear segment doubled upon itself, the side head pad, and the shield is selected to be of such a dimension that either that dimension or any greater dimension will keep a rope used for lassoing a calf from touching the area of the calf's head from under the calf's left horn to the calf's forehead.

### BACKGROUND OF THE INVENTION

### Field of the Invention

This invention relates to protective gear to be placed on the head, neck, and horns of cattle that are to be roped.

### Description of the Related Art

A number of devices exist for protecting cattle from being injured during the process of roping them.

Until the advent of the protector described in U.S. Pat. No. 5,535,707 of the present inventor, however, the available protective devices employed multiple straps and multiple pads, making them inconvenient to utilize.

U.S. Pat. No. 9,301,501 of the present inventor was based upon U.S. Pat. No. 5,535,707 but, inter alia, it does not have a separate extension and rear horn pad. Each rear horn pad is an extension of the respective side head pad with the rear horn pad and the side head pad constituting a unitary structure.

U.S. Pat. No. 9,301,501 did, though, include a left bridging pad and a right bridging pad.

### BRIEF SUMMARY OF THE INVENTION

The present Head and Horn Protector is based upon U.S. Pat. No. 9,301,501. And U.S. Pat. No. 9,301,501 of inventor Brett L. Siddoway, which was issued on Apr. 5, 2016, is hereby incorporated by reference.

The present invention, however, has eliminated the left bridging pad and the right bridging pad of U.S. Pat. No. 9,301,501.

### BRIEF DESCRIPTION OF THE SEVERAL VIEWS OF THE DRAWING

FIG. 1 is a perspective view of the Head and Horn Protector.

FIG. 2 is a cross-sectional lateral plan view looking in the direction of arrows A-A in FIG. 1 showing the combined thickness of a rear horn pad, an associated rear horn pad linear segment, a shield, a side head pad, and an associated side head pad linear segment.

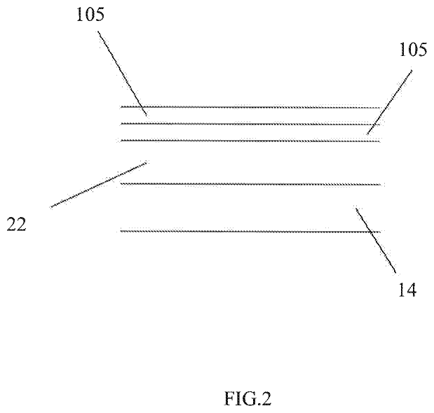

### DETAILED DESCRIPTION OF THE INVENTION

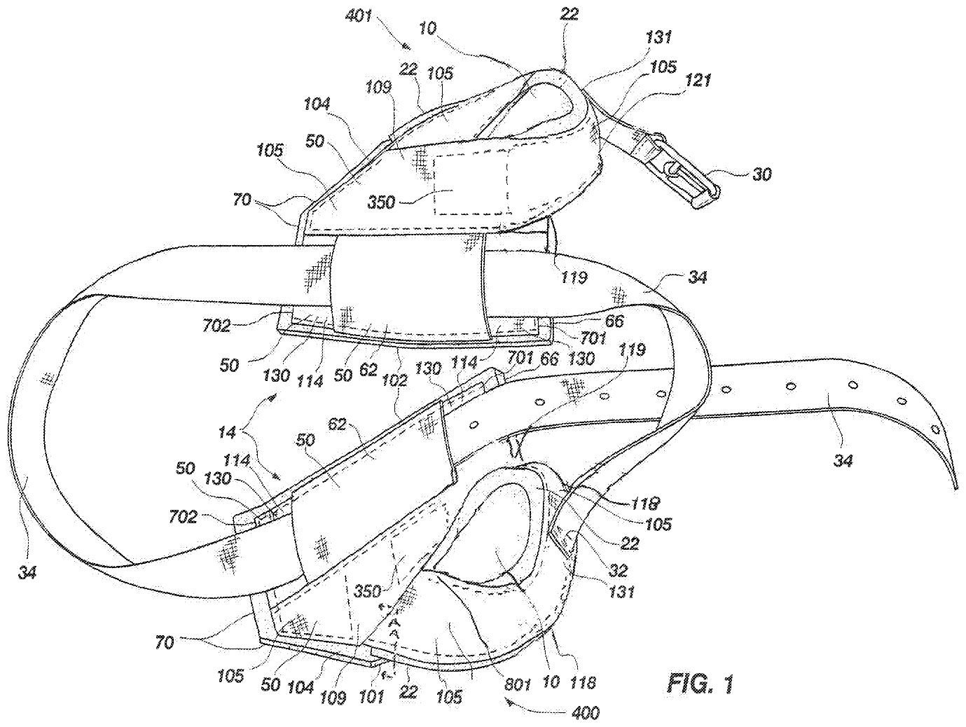

Surprisingly, the inventor has determined that the combined thickness of the right rear horn pad 22, the right rear horn pad linear segment 105 doubled since the free end 108 of the right rear horn pad linear segment 105 goes under the lower portion 109 of the right rear horn pad linear segment 105 as shown in FIG. 1, and the right shield 350 can be selected to be of such a dimension that either that dimension or any greater dimension will keep a rope used for lassoing a calf from touching the area of the calf's head under the calf's right horn, thereby eliminating the need for the right bridging pad 42. This is equally true for the left side.

This minimum dimension is preferably 0.5 inch—but can, of course, vary, depending on the size of the calf. Even more preferably, such minimum dimension is 1.5 inches.

The shield 350 can either be external, i.e., outside all other components of the Head and Horn Protector, or internal and is not necessarily rigid. The shield 350 can even be made from felt.

Connections can, optionally, be adhesive or any material or technique that will adequately, in the opinion of one of ordinary skill in the art, maintain the connection.

The buckle 30 is attached either to the right rear horn pad 22, preferably near an uppermost point of the right rear horn pad 22 or to the left rear horn pad 22, preferably near an uppermost point of the left rear horn pad 22. A first end of the strap 32 would be connected to the rear horn pad 22 to which the buckle 30 is not attached, preferably near an uppermost point of such rear horn pad 22.

Since the right bridging pad 22 and the left bridging pad 22 have been eliminated in this Head and Horn, the right bridging pad linear segment 116 and the left bridging pad linear segment 116 are also eliminated.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A head and horn protector of the type having a left side head pad, a left rear horn pad, a left guide, a right side head pad, a right rear horn pad, a right guide, a strap, and a releasable connector for the strap, wherein the improvement comprises:
a unitary left side head pad and left rear horn pad formed by extending the left side head pad substantially straight up from an upper edge of the left side head pad near a front of the left side head pad so that the left rear horn pad can be bent toward the front of the left side head pad and have a free end of the left rear horn pad placed beside the left side head pad;
a unitary right side head pad and right rear horn pad formed by extending the right side head pad substantially straight up from an upper edge of the right side head pad near a front of the right side head pad so that the right rear horn pad can be bent toward the front of the right side head pad and have a free end of the right rear horn pad placed beside the right side head pad;
a left horn pad linear segment of protective material, said left horn pad linear segment having a lower portion beginning near a lower edge of the left side head pad, said left horn pad linear segment being attached to an outer surface of the left side head pad, said left horn pad linear segment continuing along and being attached to an outer surface of the left rear horn pad, and said left horn pad linear segment proceeding past a free end of the left rear horn pad until a free end of said left horn pad linear segment is connected to the lower portion of said left horn pad linear segment;
a left side head pad linear segment of protective material commencing near a rear of the left side head pad, running transversely under the lower portion of said left horn pad linear segment, being attached to the outer surface of the left side head pad, and running longitudinally from near a lower edge of the left side head pad to near an upper edge of the left side head pad;
a left guide of protective material extending—on an outer surface of said left side head pad linear segment—from below the upper edge of the left side head pad to above the lower edge of the left side head pad, having a first edge connected to said left side head pad linear segment, and having a second edge attached to the outer surface of said left side head pad linear segment underneath the lower portion of said left horn pad linear segment;
a right horn pad linear segment of protective material, said right horn pad linear segment having a lower portion beginning near a lower edge of the right side head pad, said right horn pad linear segment being attached to an outer surface of the right side head pad, said right horn pad linear segment continuing along and being attached to an outer surface of the right rear horn pad, and said right horn pad linear segment proceeding past a free end of the right rear horn pad until a free end of said right horn pad linear segment is connected to the lower portion of said right horn pad linear segment;
a right side head pad linear segment of protective material commencing near a rear of the right side head pad, running transversely under the lower portion of said right horn pad linear segment, being attached to the outer surface of the right side head pad, and running longitudinally from near a lower edge of the right side head pad to near an upper edge of the right side head pad;
a right guide of protective material extending—on an outer surface of said right side head pad linear segment—from below the upper edge of the right side head pad to above the lower edge of the right side head pad, having a first edge connected to said right side head pad linear segment, and having a second edge attached to the outer surface of said right side head pad linear segment underneath the lower portion of said right horn pad linear segment;
a buckle attached to the right rear horn pad near an uppermost point of the right rear horn pad;
a first end of a strap connected to the left rear horn pad near an uppermost point of the left rear horn pad;
a left shield placed between said left horn pad linear segment and the left rear horn pad, beginning near a point where the bent left rear horn pad extends downward past the upper edge of the left side head pad and then proceeding downward; and
a right shield placed between said right horn pad linear segment and the right rear horn pad, beginning near a point where the bent right rear horn pad extends downward past the upper edge of the right side head pad and then proceeding downward, wherein:
the combined thickness of said right rear horn pad, said right rear horn pad linear segment doubled upon itself, said right side head pad, and said right shield is selected to be of such a dimension that either that dimension or any greater dimension will keep a rope used for lassoing a calf from touching the area of the calf's head from under the calf's right horn to the calf's forehead and the combined thickness of said left rear horn pad, said left rear horn pad linear segment doubled upon itself, said left side head pad, and said left shield is selected to be of such a dimension that either that dimension or any greater dimension will keep a rope used for lassoing a calf from touching the area of the calf's head from under the calf's left horn to the calf's forehead.

2. The head and horn protector as recited in claim 1, wherein:
said left shield is placed externally on the left horn pad linear segment, beginning near a point where the bent left rear horn pad extends downward past the upper edge of the left side head pad and then proceeding downward.

3. A head and horn protector of the type having a left side head pad, a left rear horn pad, a left guide, a right side head pad, a right rear horn pad, a right guide, a strap, and a releasable connector for the strap, wherein the improvement comprises:
a unitary left side head pad and left rear horn pad formed by extending the left side head pad substantially straight up from an upper edge of the left side head pad near a front of the left side head pad so that the left rear horn pad can be bent toward the front of the left side head pad and have a free end of the left rear horn pad placed beside the left side head pad;
a unitary right side head pad and right rear horn pad formed by extending the right side head pad substantially straight up from an upper edge of the right side head pad near a front of the right side head pad so that the right rear horn pad can be bent toward the front of the right side head pad and have a free end of the right rear horn pad placed beside the right side head pad;
a left horn pad linear segment of protective material, said left horn pad linear segment having a lower portion beginning near a lower edge of the left side head pad, said left horn pad linear segment being attached to an outer surface of the left side head pad, said left horn pad linear segment continuing along and being attached to an outer surface of the left rear horn pad, and said left horn pad linear segment proceeding past a free end of the left rear horn pad until a free end of said left horn pad linear segment is connected to the lower portion of said left horn pad linear segment;
a left side head pad linear segment of protective material commencing near a rear of the left side head pad, running transversely under the lower portion of said left horn pad linear segment, being attached to the outer surface of the left side head pad, and running longitudinally from near a lower edge of the left side head pad to near an upper edge of the left side head pad;
a left guide of protective material extending—on an outer surface of said left side head pad linear segment—from below the upper edge of the left side head pad to above the lower edge of the left side head pad, having a first edge connected to said left side head pad linear segment, and having a second edge attached to the outer surface of said left side head pad linear segment underneath the lower portion of said left horn pad linear segment;
a right horn pad linear segment of protective material, said right horn pad linear segment having a lower portion beginning near a lower edge of the right side head pad, said right horn pad linear segment being attached to an outer surface of the right side head pad, said right horn pad linear segment continuing along and being attached to an outer surface of the right rear horn pad, and said right horn pad linear segment proceeding past a free end of the right rear horn pad until a free end of said right horn pad linear segment is connected to the lower portion of said right horn pad linear segment;
a right side head pad linear segment of protective material commencing near a rear of the right side head pad, running transversely under the lower portion of said right horn pad linear segment, being attached to the outer surface of the right side head pad, and running longitudinally from near a lower edge of the right side head pad to near an upper edge of the right side head pad;
a right guide of protective material extending—on an outer surface of said right side head pad linear segment—from below the upper edge of the right side head pad to above the lower edge of the right side head pad, having a first edge connected to said right side head pad linear segment, and having a second edge attached to the outer surface of said right side head pad linear segment underneath the lower portion of said right horn pad linear segment;
a buckle attached to the right rear horn pad near an uppermost point of the right rear horn pad;
a first end of a strap connected to the left rear horn pad near an uppermost point of the left rear horn pad;
a left shield placed between said left horn pad linear segment and the left rear horn pad, beginning near a point where the bent left rear horn pad extends downward past the upper edge of the left side head pad and then proceeding downward; and
a right shield placed between said right horn pad linear segment and the right rear horn pad, beginning near a point where the bent right rear horn pad extends downward past the upper edge of the right side head pad and then proceeding downward, wherein:
the combined thickness of said right rear horn pad, said right rear horn pad linear segment doubled upon itself, said right side head pad, and said right shield is at least 0.5 inch, and the combined thickness of said left rear horn pad, said left rear horn pad linear segment doubled upon itself, said left side head pad, and said left shield is at least 0.5 inch.

4. The head and horn protector as recited in claim 1, wherein:
said left shield is placed externally on the left horn pad linear segment, beginning near a point where the bent left rear horn pad extends downward past the upper edge of the left side head pad and then proceeding downward.

5. An improved head and horn protector of the type having a left side head pad, a left rear horn pad, a left guide, a right side head pad, a right rear horn pad, a right guide, a strap, and a releasable connector for the strap, wherein the improvement comprises:
a unitary left side head pad and left rear horn pad formed by extending the left side head pad substantially straight up from an upper edge of the left side head pad near a front of the left side head pad so that the left rear horn pad can be bent toward the front of the left side head pad and have a free end of the left rear horn pad placed beside the left side head pad;
a unitary right side head pad and right rear horn pad formed by extending the right side head pad substantially straight up from an upper edge of the right side head pad near a front of the right side head pad so that the right rear horn pad can be bent toward the front of the right side head pad and have a free end of the right rear horn pad placed beside the right side head pad;
a left horn pad linear segment of protective material, said left horn pad linear segment having a lower portion beginning near a lower edge of the left side head pad, said left horn pad linear segment being attached to an outer surface of the left side head pad, said left horn pad linear segment continuing along and being attached to an outer surface of the left rear horn pad, and said left horn pad linear segment proceeding past a free end of the left rear horn pad until a free end of said left horn pad linear segment is connected to the lower portion of said left horn pad linear segment;
a left side head pad linear segment of protective material commencing near a rear of the left side head pad, running transversely under the lower portion of said left horn pad linear segment, being attached to the outer surface of the left side head pad, and running longitudinally from near a lower edge of the left side head pad to near an upper edge of the left side head pad;
a left guide of protective material extending—on an outer surface of said left side head pad linear segment—from below the upper edge of the left side head pad to above the lower edge of the left side head pad, having a first edge connected to said left side head pad linear segment, and having a second edge attached to the outer surface of said left side head pad linear segment underneath the lower portion of said left horn pad linear segment;
a right horn pad linear segment of protective material, said right horn pad linear segment having a lower portion beginning near a lower edge of the right side head pad, said right horn pad linear segment being attached to an outer surface of the right side head pad, said right horn pad linear segment continuing along and being attached to an outer surface of the right rear horn pad, and said right horn pad linear segment proceeding past a free end of the right rear horn pad until a free end of said right horn pad linear segment is connected to the lower portion of said right horn pad linear segment;
a right side head pad linear segment of protective material commencing near a rear of the right side head pad, running transversely under the lower portion of said right horn pad linear segment, being attached to the outer surface of the right side head pad, and running longitudinally from near a lower edge of the right side head pad to near an upper edge of the right side head pad;
a right guide of protective material extending—on an outer surface of said right side head pad linear segment—from below the upper edge of the right side head pad to above the lower edge of the right side head pad, having a first edge connected to said right side head pad linear segment, and having a second edge attached to the outer surface of said right side head pad linear segment underneath the lower portion of said right horn pad linear segment;
a buckle attached to the right rear horn pad near an uppermost point of the right rear horn pad;
a first end of a strap connected to the left rear horn pad near an uppermost point of the left rear horn pad;
a left shield placed between said left horn pad linear segment and the left rear horn pad, beginning near a point where the bent left rear horn pad extends downward past the upper edge of the left side head pad and then proceeding downward; and
a right shield placed between said right horn pad linear segment and the right rear horn pad, beginning near a point where the bent right rear horn pad extends downward past the upper edge of the right side head pad and then proceeding downward, wherein:
the combined thickness of said right rear horn pad, said right rear horn pad linear segment doubled upon itself, said right side head pad, and said right shield is at least 1.5 inch, and the combined thickness of said left rear horn pad, said left rear horn pad linear segment doubled upon itself, said left side head pad, and said left shield is at least 1.5 inches.

6. The head and horn protector as recited in claim 1, wherein:
said left shield is placed externally on the left horn pad linear segment, beginning near a point where the bent left rear horn pad extends downward past the upper edge of the left side head pad and then proceeding downward.
